(19) United States
(12) Patent Application Publication
(10) Pub. No.: US 2016/0360712 A1
(43) Pub. Date: Dec. 15, 2016

(54) GROW LIGHTING AND AGRICULTURAL SYSTEMS AND METHODS

(71) Applicant: Biological Innovation & Optimization Systems, LLC, Melbourne, FL (US)

(72) Inventors: Neil Yorio, Indian Harbour Beach, FL (US); Eric Thosteson, Satellite Beach, FL (US); Robert Soler, San Marcos, CA (US); Shane Sullivan, Indialantic, FL (US); Eliza Balestracci, Satellite Beach, FL (US); Wei Sun, Indialantic, FL (US); Richard LeClair, Palm Bay, FL (US)

(73) Assignee: Biological Innovation & Optimization Systems, LLC

(21) Appl. No.: 15/181,622

(22) Filed: Jun. 14, 2016

Related U.S. Application Data
(60) Provisional application No. 62/175,724, filed on Jun. 15, 2015.
(60) Provisional application No. 62/323,004, filed on Apr. 15, 2016.

(51) Int. Cl. A01G 9/20; F21V 29/83; F21V 29/58; A01G 1/00; A01G 31/06; A01G 9/24; A01G 9/12; A01G 9/02; F21V 21/00; A01G 7/04

(52) U.S. Cl. CPC A01G 9/20; F21V 21/00; F21V 29/83; F21V 29/59; A01G 7/045; A01G 31/06; A01G 9/24; A01G 9/245; A01G 9/12; A01G 9/022; A01G 1/001; F21Y 2115/10

(57) ABSTRACT

Embodiments of the invention relate generally to systems and methods for improving efficiency and yield in plant grow operations including improvements in LED grow lighting fixtures, components and systems, and their applications to plant grow operations. Improvements for directional control and efficiency in lighting and methods and systems used in plant grow applications and operations including temperature regulation and control, soil and grow media regulation and vertical farming are also disclosed.

### RELATED APPLICATIONS

This application claims priority to and the benefit of U.S. Provisional Application No. 62/175,724, filed Jun. 15, 2015, U.S. Provisional Application No. 62/323,004, filed Apr. 15, 2016, and U.S. Non-Provisional application Ser. No. 15/148,194, filed May 6, 2016. The contents of each of those applications are incorporated herein in their entirety.

### FIELD OF THE INVENTION

Embodiments of the invention relate generally to systems and methods for improving efficiency and yield in plant grow operations including improvements in LED grow lighting fixtures, components, systems and applications in plant grow operations.

### BACKGROUND OF THE INVENTION

Indoor agricultural and horticultural operations where plants are grown under artificial lighting are increasingly commonplace. Some advantages of indoor plant growth operations include allowing for extended growing cycles, increased yield per unit area (e.g., vertical framing), fine tuning of environmental variables including light output to enhance plant yield, security and enhanced ability to monitor the operation. Various types of grow lights are available including incandescent, fluorescent, compact fluorescent, metal halide, high pressure sodium, and light emitting diode (LED) based lighting. Each type presents unique characteristics, such as, cost to purchase, cost to operate, efficiency, light spectrum and radiant power output, etc. Important features of plant grow lights include providing the appropriate amount of photosynthetically active radiation (PAR) to ensure and optimize plant growth. Providing the appropriate radiant spectrum and power while minimizing energy consumption is another important goal of indoor growing operations and a benchmark metric of plant growth fixtures.

Light emitting diode (LED) technology is rapidly being applied to the agricultural and horticultural fields to allow for high efficiency indoor plant cultivation and growth. The increased energy efficiency of LED technology compared with other lighting solutions coupled with the reduction of costs of the LED themselves are increasing the number of LED applications and rates of adoptions across industries. Examples of such industries and markets include plant growing applications spanning the breadth from small indoor home greenhouses and nurseries to full scale indoor farming facilities. LEDs and associated technologies are becoming increasingly electrically efficient and are supplanting other lighting technologies because of this efficiency and associated cost savings. LED technology can also deliver greater reliability and lighting fixture longevity compared with other lighting technologies.

Importantly, LED technology and solid state lighting (SSL) in general provide platforms to allow the tailoring and customization of light output spectra to meet the demands of any specific application thereby increasing efficiency and optimizing the light output to meet the desired application. This feature of tailoring and tuning output spectra of LED fixtures can be used in the grow lighting and other arenas to provide the specific wavelengths and wavelength ranges tailored and optimized to the specific application. For example, LED lights with specific wavelengths in the far red and ultraviolet bands are of interest to some growers for use during certain stages of plant growth. Illumination of plants with these specific wavelength regions can provoke or elicit specific and positive plant development and growth responses. Generally, the tailoring of the output light spectrum to optimize the amount photo-synthetically radiation incident on plant targets, depending on the plant species and/or growth cycle, can both reduce energy consumption and enhance plant growth and yield.

FIGS. 1a and 1b illustrate examples of conventional manufactured LED packages 8 comprising an LED light source, chip, or die 10, a lens 12, and other components represented generally by a reference character 14 (e.g., heat sink, printed circuit board, outer package, and anode and cathode leads) to which the LED chip is mechanically or electrically connected. A common type of lens 12 as shown is generally dome shaped and is made of a transparent material such as silicone. The shape, thickness and material of the lens 12 determines the spatial light output distribution of the light generated by the LED 10. The LED package 8 typically is electrically connected to a printed circuit board (PCB) and powered by a power source to generate light. LED packages range in size depending on manufacturer and performance as well as number of individual LED die making up the package. The lens 12 of an LED package 8 is typically designed such that the LED package 1 produces or outputs a specific beam angle of the light. FIG. 1a depicts an example of and LED package with a relatively wide light beam angle output 20 and FIG. 1b shows an LED package with a relatively narrow beam angle output 22.

Often however, a lighting designer or other user of LED packages needs to tailor the output beam angle for their specific application, but are limited to using whatever LED packages are readily available. These off-the-shelf LED packages may not match precisely the beam angle desired. In order to achieve the desired output beam angle, a secondary lens or other optic is commonly employed to redirect the light output by the LED package to achieve the desired output beam angle. FIG. 1c illustrates an example of this scenario. Refractive optic 16 is used to reduce the beam angle of the light output by the LED package 8 producing a narrower beam of light. The use of a secondary optic however results in reduced light transmission on the order of 10% or more due to reflections on the surfaces of the secondary optic. This significantly diminishes the efficiency of the system.

Protecting the LED packages from the ambient environment, for example from water and contaminant ingress, is typically accomplished by securing a transparent sheet or other form (e.g., glass, acrylic, polycarbonate, etc) around and encasing the LED packages. Although this approach does insulate the LED packages from the potential of water and other intrusions, the addition of the new material reduces the light transmitted to the environment because of the reflections that occur when the light travels through different media and is refracted and reflected at each media boundary (due to the differences in the respective media indices of refraction). Enclosing LED packages with a transparent cover to protect them from water and other contaminants results in a less efficient lighting system. In a plant grow operations, the angle at which light is emitted is important for optimizing both plant growth and lighting efficiency. Arranging the lighting fixtures in such a way as to insure that light is directed on plants as needed and is not wasted by being directed to areas where there are no plants can be a particular challenge in plant grow operations. The ability to adjust and customize the beam angle at which the light is emitted from the LED lighting fixture, while maintaining or minimizing and reduction in lighting efficiency would be of great benefit. Also, protecting the LED light engine and components from contaminants and particularly moisture, which is prevalent in the humid conditions of a grow operation, while maximizing light transmission is a continual challenge.

Vertical indoor farming applications, in which there are two or more levels of plants, for example one above the other, are becoming more common because they allow a much more efficient use of the areal space within an enclosed grow facility. Vertical farming configurations may result in multiple levels of LED grow light fixtures, each generating waste heat which cumulatively may cause an undesired rise in air and plant temperature. The ability to remove the waste heat or otherwise use it in a productive capacity would be of benefit to vertical farming applications using LED grow light fixtures.

Using sensors to monitor parameters of the grow environment and adjust these parameters to desired target levels can enhance growth efficiency and yield. While air temperature measurements are routinely made within a grow facility, these data may not accurately match the actual plant or plant canopy temperatures, both of which are important variables to be controlled during plant growth. The ability to accurately manage plant canopy temperatures in real time and adjust environmental conditions in response to reach optimal canopy temperatures would be of benefit and contribute to the capability of optimizing plant growth conditions throughout the growing cycle and enhancing plant yield.

### BRIEF SUMMARY OF EMBODIMENTS OF THE INVENTION

Embodiments of the invention include systems and methods for improving efficiency and yield in plant grow operations including improvements in LED grow lighting fixtures and components, and their use and application to plant grow operations.

Embodiments include methods and systems for achieving improvements for directional control and efficiency in lighting.

Embodiments of the invention include lighting fixtures with integrated temperature monitoring capabilities and associated methods and systems for temperature regulation and control in plant grow applications and operations.

Embodiments include methods and systems for using plant growth media, such as hydroponic solution or soil, to remove and utilize LED waste heat. Some embodiments relate to systems, methods, and components used for vertical farming application.

Embodiments of the invention include a method for sinking heat from LED grow lights using plant growth media in vertical farming and other plant growth applications comprising, configuring an LED grow light, comprising an LED light engine on a first side and a heat sink on a second side, to illuminate one or more plant growth areas below the grow light, and configuring a planter, for containing plant grow media, in relation to the LED grow light such that a portion of the planter is proximal or adjacent to the heat sink of the LED grow light, and depositing a plant grow medium into said planter, and operating said LED grow light to illuminate said plant grow areas below the grow light wherein heat generated by the LED grow light is at least partially transferred to said grow medium. Embodiments also include methods of and systems for circulating a fluid through or adjacent to a first planter to remove heat from the planter. Other embodiments comprising transferring heat from a first planter to a second planter by means of fluid circulation.

Embodiments of the invention include a system for vertical farming or indoor plant grow operations comprising, a rack or other support structure comprising at least one lower level and one upper level, the upper level disposed vertically above the lower level; a first LED grow light comprising an LED light engine, a heat sink and support means for securing it to the lower level such that the LED light engine is oriented in generally a downward direction to illuminate an area below it and the heat sink is oriented generally in an upward direction opposite the light engine; a second LED grow light with support means for securing it to the upper level such that the LED light engine is oriented generally in a downward direction to illuminate a plant grow area underneath and wherein when both LED grow lights are secured to said rack the second LED grow light will be vertically disposed above the first LED grow light; and, a support means at the lower level for placing and supporting a planter containing plant grow media above and adjacent to the heat sink of said first LED grow light such that when a planter containing grow media is placed adjacent to the heat sink of the first LED grow light, heat generated by the operation of said first LED grow light is at least partially transferred to the planter.

Embodiments also include systems for circulating fluid adjacent or proximate to planters to remove heat from an LED grow light or from a planter and means for circulating hydroponic fluid through one or more planters remove or add heat from the planter or grow media therein. Other embodiments include regulating planter or grow media temperature by circulating fluid from one planter to another.

Other embodiments of the invention include an LED grow light with integrated planter component for vertical farming applications comprising, an LED light engine component, a heat sink component for sinking heat away from the LED light engine, and a planter component for containing plant growth media wherein said planter component is in thermal contact with said heat sink component and wherein a portion of said planter component sinks heat away from said LED light engine. Embodiments include means for carrying or circulating fluid within or adjacent said planter component to facilitate heat transfer.

### BRIEF DESCRIPTION OF THE DRAWINGS

FIGS. 1a-c show examples of conventional LED packages and light engines illustrating beam angle control and environmental protection with secondary optics.

FIGS. 2a-c illustrate LED light engines with potting material and methods thereto according to some embodiments of the invention.

FIGS. 3a-c illustrate systems and operational aspects of heat transfer from LED grow lights to adjacent plant growth media and systems and methods of vertical farming and according to some embodiments of the invention.

FIGS. 4a-c illustrate LED grow lights integrated with plant trays or planters according to some embodiments of the invention.

FIG. 5 illustrates an LED grow light fixture with integrated adjustable temperature sensor and applications thereto according to some embodiments of the invention.

FIGS. 6a-b illustrate LED grow light fixtures with integrated adjustable temperature sensors and applications thereto according to some embodiments of the invention.

FIGS. 7a-e illustrate a variety of LED grow lights in flexible form factors and applications thereto according to some embodiments.

### DETAILED DESCRIPTION OF EMBODIMENTS OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

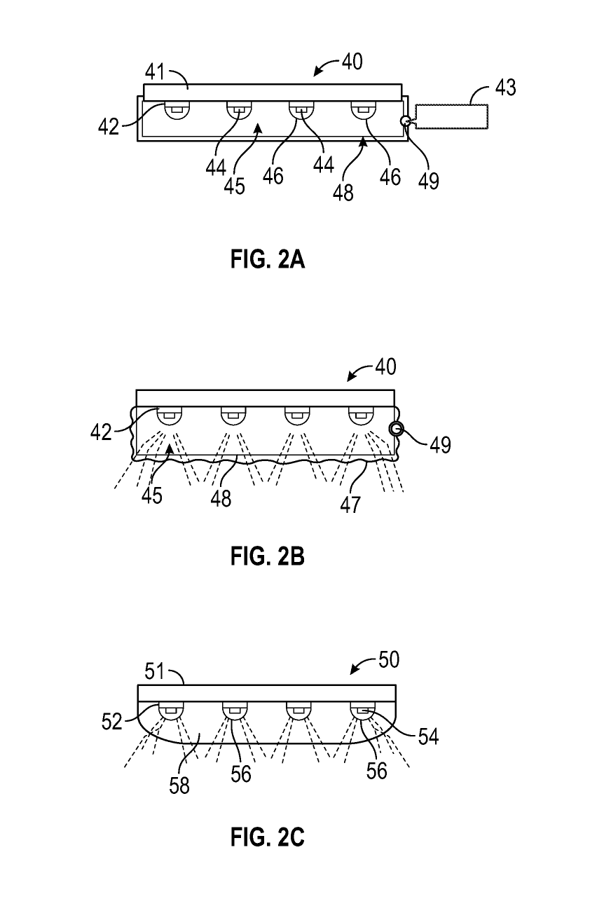

In one embodiment of the invention a transparent sheet or enclosure is used to encase the LED light packages or LED light engine and an index matched potting material is used to fill the void between the LED packages and the transparent enclosure. The filling of the void (which typically comprises air), with an index matching material prevents or reduces optical losses that would otherwise occur at the air-optic boundaries. FIGS. 2a-b illustrate embodiments of the invention. LED light engine 40 comprises a printed circuit board 41 containing multiple LED packages 42, each package comprising an LED die 44 and a silicone lens 46. A transparent enclosure 48, for example comprised of glass or acrylic or polycarbonate, is secured to encase the light emitting side of light engine 40. The enclosure 48 includes an injection port 49 for injecting potting material. In one embodiment, index matched potting material 45, for example in fluid form, is injected via an injection device 43 through port 49 filling the interior region formed by the enclosure 48 and surrounding the LED packages 42. The potting material may be injected via a hose or any conventional injection device 43 or other means as will be evident to those skilled in the art. The potting material 45 is chosen such that the index of refraction of the potting material 45 is close to or identical with that of the enclosure 48, the silicone lens 46 or both. A variety of such potting materials are available as will be known to those skilled in the art.

The use of a potting material with a matched index of refraction minimizes reflections and optical losses thereby increasing the efficiency of the lighting system. In some embodiments the surface 47 of the enclosure 48 is shaped or patterned in order to obtain a specific beam angle or optimize light output from the light engine or lighting device. FIG. 2b illustrates an LED light engine 40 enclosed by enclosure 48 and filled with index matching potting material 45. The surface 47 of the enclosure 48 is shaped or patterned in such a way as to produce the desired optical output distribution. The inner surface, outer surface or both surfaces of enclosure 48 may be shaped or patterned depending on the embodiment and application. In this example, the beam angle output by the LED packages 42 is effectively reduced while maintaining optical efficiency.

Another embodiment of the invention, as shown in FIG. 2c, comprises a light engine 50 which includes an overlay or overmold of potting material (e.g., index matched). Light engine 50 comprises a plurality LED packages 52, each including an LED die 54 and encapsulant lens 56, with each of the packages 52 electrically attached to a larger printed circuit board 51. Index matched potting material is overlaid or overmolded onto the light engine 50 encapsulating the LED packages 52. The LED packages 52 are thereby encased in a clear potting material 58, for example a potting material with an index of refraction matching that of the LED lens 56. Such potting material serves to protect and insulate the packages 52 from the ambient environment, including water and contaminant ingress.

The overmolded potting material may also be shaped or patterned to achieve a desired light output beam angle and spatial light distribution at a particular target plane (not shown). This embodiment achieves the desired spatial light distribution without use of supplemental lenses or additional sheet enclosure as shown in the prior art. The overlaying or overmolding of the index matched potting material 58 can be accomplished according to conventional methods as will be evident to those skilled in the art. The surface structure of the overmolded potting material 58 may be designed to achieve one or more particular light output parameters including beam angle. The shape and configuration of the outside surface of the potting material may be determined by the mold in which it is formed or may be created (e.g., machined) after overlaying the potting material.

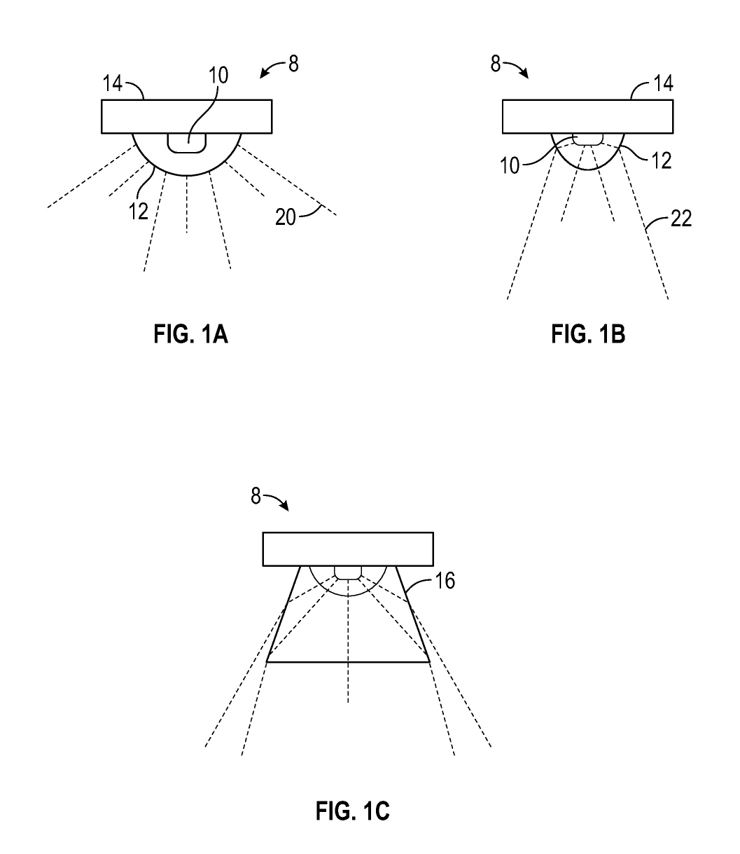

Use of the potting material reduces the light attenuation because there is no surface spaced at a distance from the LED chip that can produce light reflections from the LEDs, such as in the arrangement shown in FIG. 1c. The potting material 58 is continuous with the surfaces of the lenses 56 of the LED packages 52 which significantly reduces light reflections. Because there are no or fewer number of reflections, the total attenuation is significantly reduced compared with the conventional air interface. Use of the potting material 58 provides a more efficient and waterproof light delivery system, avoids the use of additional lenses to control the light beam pattern, and offers a more durable LED system as the potting material makes the LED system more rugged. The potting material also provides protection from water ingress. These features are advantageous for a light fixture operating in wet environments and eliminate the need for separate ingress protection and/or a separate and additional lens.

In some embodiments, the mold used to apply the potting material to the LED assembly is shaped to produce an overmold which further improves the light distribution such that the clear potting material itself acts as a refractive lens. The LED packages 52 may be mounted at various angles relative to the fixture to further optimize the light distribution. Also, because of the expected statistical variability in radiant output due to anomalies in LED package manufacturing processes, the known distribution of light output as reported by the manufacturer (e.g., as a result of binning) can be used to position and locate each LED package on an LED light engine board to further optimize the resulting spatial distribution of the output and to minimize glare and optical losses.

In other embodiments of the invention, one or more LED grow light fixtures are arranged or configured in relation to the plant growth medium providing means for efficient removal of heat from the LED fixture(s) and a means for providing thermal energy to the plant growth media. A planter, which can contain grow media such as soil or hydroponic solution for instance, is placed in thermal contact with the heat sink of LED grow light fixtures thereby providing efficient means of transferring heat from the LED light engine to the plant grow media. As is well known to those skilled in the art, an LED or LED light engine may generate significant amounts of heat during operation, and this heat needs to be removed from the LED light engine in order to maintain the stability, operational efficiency and longevity of the LEDs themselves. Typically, a metallic or other thermally conductive material is placed in proximity to the LEDs and function to sink heat away from the LEDs while dissipating the heat to the environment. Conventional heat sinks may be in any desired form and may include fins or other shapes to increase surface area to most effectively sink heat away from the LEDs.

Embodiments of the invention include methods and systems for the placement of planters, for example containers that hold the plant growth medium into which the roots of the plants are immersed, directly adjacent (e.g., above) the heat sinks of one or more LED grow fixtures. In some embodiments, including hydroponics growing configurations, a circulation system including one or more pumps may be used to circulate the hydroponic solution thereby efficiently removing waste heat that has been generated by the LEDs and transferred to the hydroponic solution and regulating the temperature of the growth media.

Other embodiments of the invention include an integrated LED array on the bottom of a hydroponic or other plant growth support tray. This type of integrated light fixture-planter allows for an efficient sinking of heat away from the LEDs and into the grow media, (e.g., water or soil), and has broad applicability in vertical farming applications.

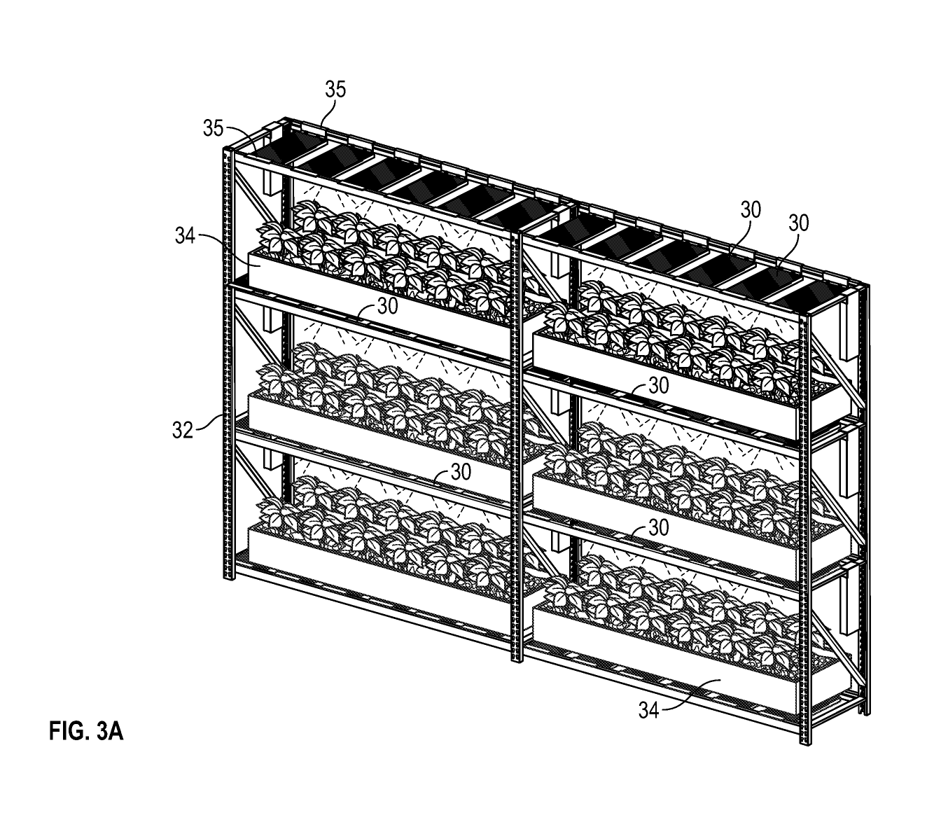

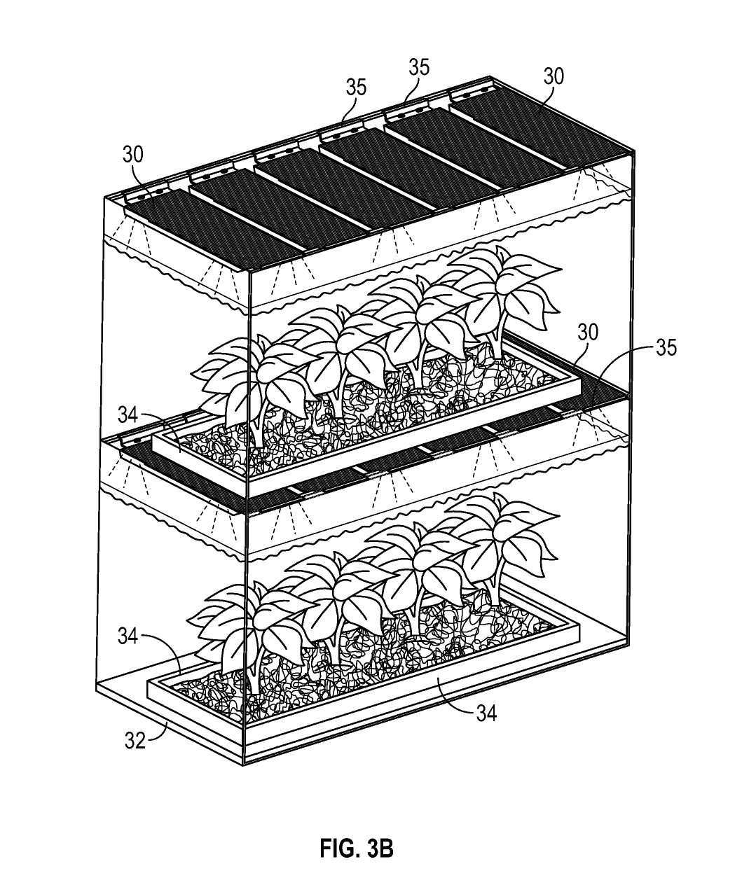

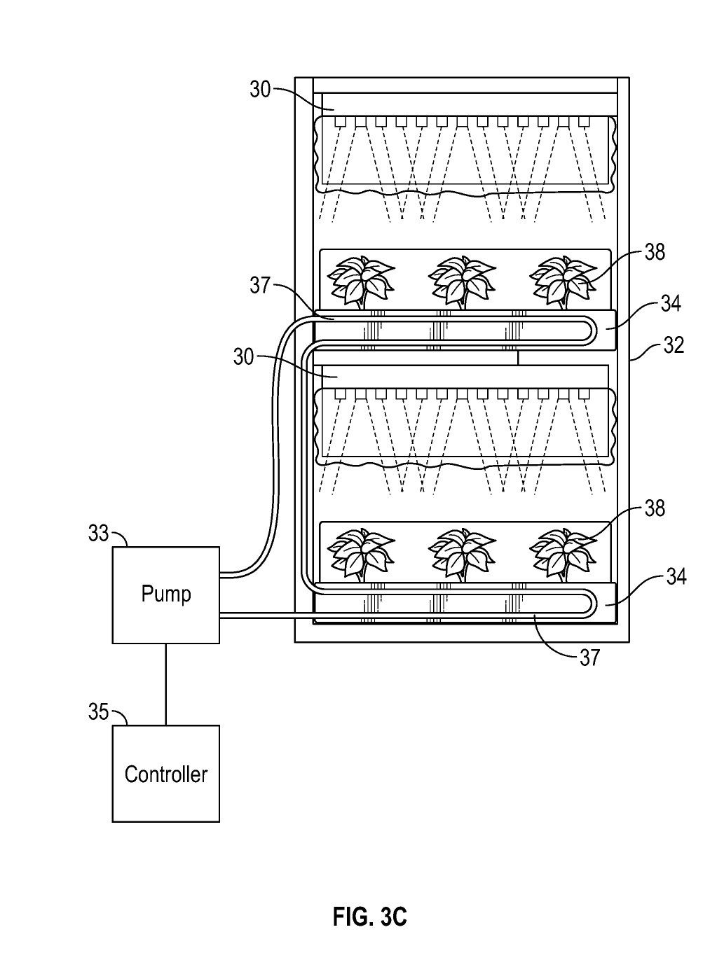

Grow facilities may be configured for vertical farming in which planters, the containers in which the plants are grown (e.g., either in soil or hydroponically), are placed on vertically-stacked shelves, for example by mounting on to a wall surface or securing in a standing rack. FIGS. 3a-c illustrate example embodiments of the invention in vertical farming applications. Grow light fixtures 30 are mounted on the shelves of a rack 32. In this example, flanges 35 or other hangers that are integrated with the fixture provide the attachment support to the rack. The grow light fixtures 30 secured on an upper shelf of the rack illuminate plants on the shelf directly below. The heat sink of the fixture 30 faces opposite the LED light engine and is generally adjacent or proximal to the rack shelf to which it is supported. Plant trays or planters 34 are placed on the shelves and are adjacent or proximal to, the heat sinks of the LED fixture directly below. In these embodiments, a portion of the heat generated by the LED light fixtures 30, which are on a particular shelf of the rack, is transferred to the planters 34 that are on the same shelf and that are directly above and in thermal contact with the fixtures 30. A portion of this heat is transferred to the grow media (not shown) contained in the planters 34.

In some embodiments, the planters are integrated with the rack itself and the LED lights are inserted directly underneath the planters. In other embodiments, the planters are placed on top of the LED fixtures. In these embodiments and additional shelf or rack support brace (not shown) may be used to support the planter so that its weight is not resting on the LED fixture. In still other embodiments a thermal transfer medium is placed between the LED fixture and planter. In some embodiments, the planters contain hydroponic grow media. The thermal connection (e.g., direct contact or close proximity) between the planters and heat sink of the LED fixture allows for the efficient transfer of heat from the LED fixtures 30 to the grow media of the planter 34. In these examples, heat generated by the LED fixture is efficiently removed from the fixture and at least a portion of it is transferred into the growth medium.

In additional embodiments, a circulation system comprising a pump and fluid conduits may be used to circulate water or hydroponic solution contained in the planters to remove any excess heat and regulate the temperature of the fluid contained within the planter. In these embodiments, heat is removed from the LED fixture and used to warm the grow medium which provides benefits including optimizing the efficiency of LED operation and maintaining optimal temperatures for plant growth. Planters may include temperature sensors and the fluid circulation system may be controlled by a controller (e.g., networked computer) based on the temperature of the hydroponic solution according to some embodiments.

FIG. 3c illustrates another embodiment in which a fluid circulation system is used to both sink heat from the LED fixtures and maintain optimal temperature of the plant grow media. Shown is a rack 32 comprising shelves on which LED light fixtures 30 and hydroponic planters 34 are mounted. According to some embodiments of the invention, the grow light fixtures 30 are integrated with the planters 34 as an assembly or the fixtures 30 are attached directly to a bottom surface of the planter 34. In this embodiment, the planters 34 include integrated fluid conduits 37 that provide means of planter fluid ingress and egress. A pump 33 provides the means of circulating the fluid. The pump may be manually operated or according to some embodiments is operated automatically by a controller 35 that controls the circulation of the fluid depending on ambient or other conditions. For example, temperature measurements of the planters or grow media or of the LED fixtures may be used by the controller 35 to adjust fluid flow through the planters 34 in order to maintain optimum temperatures of the grow media, LED fixtures or both.

In some embodiments, the temperature of the hydroponic solution is monitored and controlled using known heat exchanging techniques. The planters 34 may include one or more temperature sensors (not shown) for monitoring in real-time the temperature of the planter 34 and grow medium therein. For example, the solution can be pumped out of the planter, circulated in hoses and pipes which are in thermal contact to the environment, and then reintroduced into the planter after having lost heat to the environment. A localized temperature monitor and control may be more efficient than a distributed system of temperature monitoring and control in some embodiments.

In other embodiments a soil-based growing medium is used. The soil, typically moist, sinks the heat from the LED light fixture as described above. In some embodiments, water irrigation systems can be routed in proximity to the LED fixture, absorbing heat therefrom, prior to being delivered to and watering the plant soil. In these embodiment the soil is warmed by waste heat from the LED-based lighting fixtures. This obviates the need for the use of a heat mat to heat the soil and thereby improve plant growth. Such heat mats are commonly used in plant production facilities for supporting the growth of seedlings, cuttings or clones, or other applications where warmer root zone temperatures are warranted.

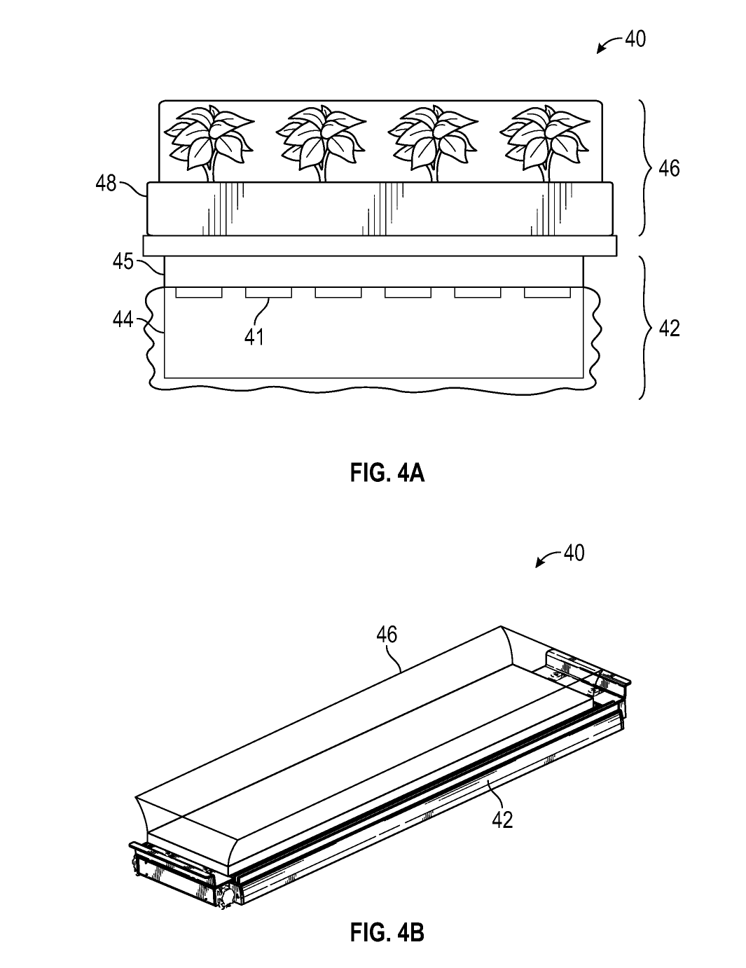

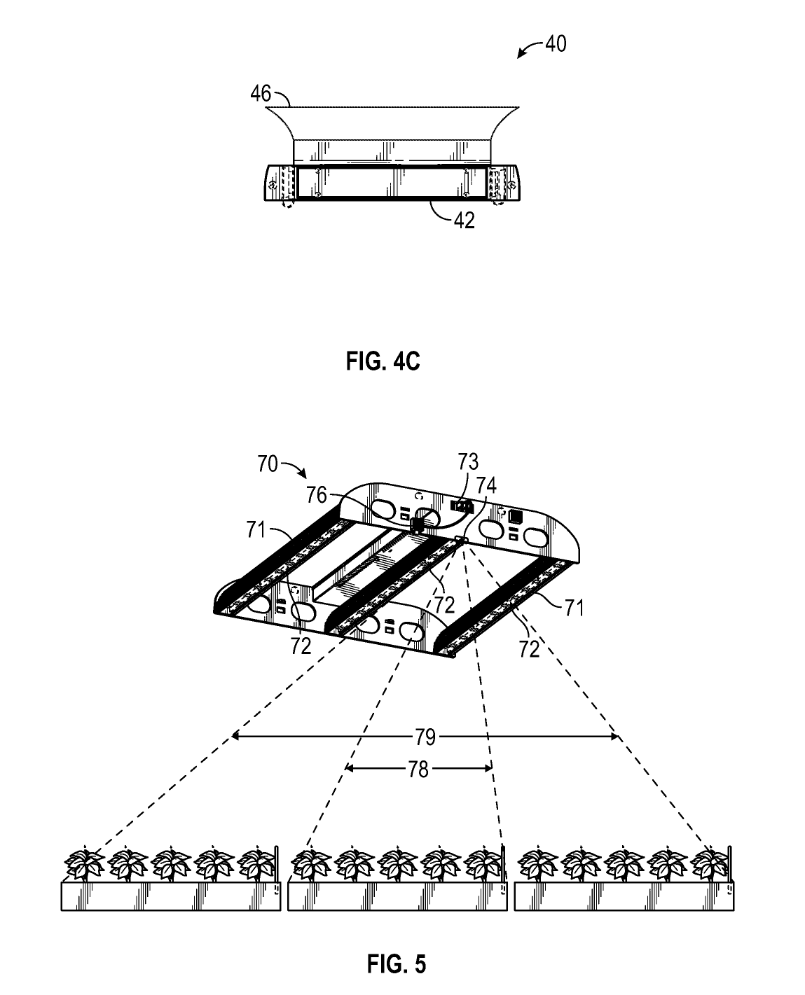

In some embodiments, the heat sink for the LED fixture comprises a molded thermally conductive material that is shaped wholly or partially as a plant grow tray or planter. In these embodiments, particularly applicable to vertical farming applications, the integrated unit includes both an LED fixture and an integrated planter unit that functions as a heat sink. The unit may be installed on a rack or other support system wherein the unit has an LED lighting component that illuminates plants below it (e.g., on the rack below) and a planter heatsink that hold grow media (e.g., hydroponics or soil) and plants. FIGS. 4a-c show example embodiments of such an integrated fixture 40 and includes both a lighting portion 42 and an integrated grow tray or planter 46. The lighting portion 42 comprising one or more LEDs or LED light engines 43, an optic 44, and PCB or LED board 45, and other components including a power supply and power cable (not shown). The planter portion 46 comprises at least partially of thermally conductive material 48, and may or may not contain fins or other surface area enhancing features. The planter may also include ports for attaching hoses or the like for fluid delivery. In some embodiments, the fixture includes an integrated pump and/or circulation system.

Another embodiment of the invention includes an LED plant grow fixture with one or more integrated (or attachable) and adjustable temperature sensors, that provides the capability for real-time plant canopy temperature measurements. In some embodiments the monitoring of plant temperatures using an integrated sensor is coupled with feedback signaling to one or more systems such as fans and the HVAC control system to automatically adjust and regulate ambient air flow and temperature in order to maintain optimal plant and canopy temperature. In some embodiments an infrared thermopile sensor with adjustable field of view is integrated into (or attached to) an LED lighting fixture and used to measure the temperature of specific regions of the plant canopy. This real time and specific canopy area temperature data is used to adjust environmental temperature and airflow in order to optimize the growth of the plants and in some embodiments to create, eliminate, or adjust microclimates within a grow facility. The use of a temperature measuring sensor with adjustable field of view allows for the surface temperature of specific plants or specific portions of the canopy to be measured thereby providing a more accurate measurement of canopy temperature as compared with a sensors or fixed field of view that may measure temperatures outside the areas of interest and thereby yield a less accurate measure the canopy area of interest. Other methods of measuring temperature may be used as will be evident to those skilled in the art.

Thermopile sensors allow remote measurement of the temperature of objects within the field of view of the sensor. The temperature measurement provided by these sensors may approximate an average temperature of all of the objects within the field of view of the sensor. Although air temperature is typically used as a proxy for plant temperature, the relationship between plant and air temperature is variable and may be dependent upon a variety of factors including the type of lighting system used, the proximity of the lights to the plants and the presence of other environmental heat sources or sinks relative to the plants and plant canopy. According to some embodiments, one or more thermopile sensors are used to measure temperature and are so configured such that the field of view of each of the sensors includes primarily only the plant canopy, or portions of the plant canopy of interest. Because the field of view of the temperature sensors is adjusted to exclude non-canopy areas, an accurate temperature of plant and plant canopy surfaces can be obtained. Furthermore, because the measurement is representative of the spatial average over the plant canopy, it represents a statistically more accurate measure than a single point measurement produced from a temperature sensor in contact with a plant.

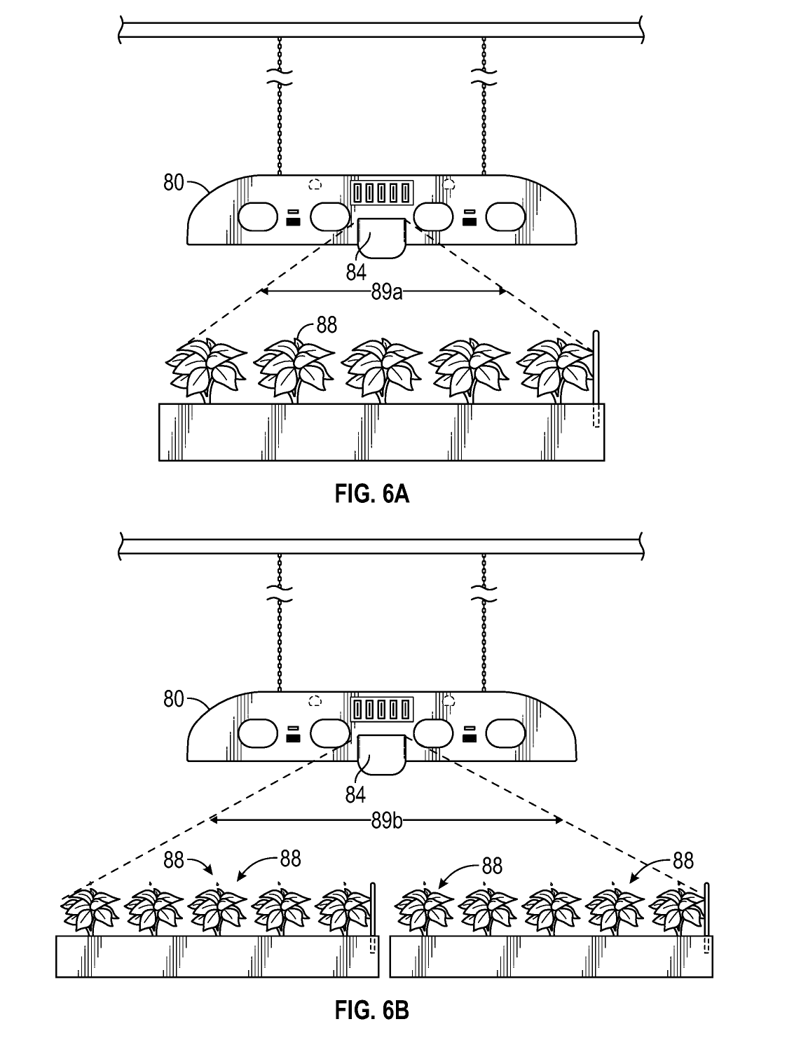

FIGS. 5 and 6a-b illustrate grow light fixtures with integrated and adjustable thermopile sensors according to some embodiments. Other types of adjustable sensors may also be used. As shown in FIG. 5 grow light fixture 70 includes light bars 71 containing one or more LED light engines 72 and an integrated adjustable thermopile sensor 74. In other embodiments, the adjustable sensor may be a clip on type that may be attached and detached from a specific fixture with ease (as illustrated by 76 for example). In some embodiments the sensor may be powered directly by the fixture power supply (not shown) or may be powered by a USB power port 73 integrated within the fixture. The target area for temperature measurements may be adjusted by adjusting the orientation and/or configuration of the thermopile sensor 74 to measure temperatures within a relatively narrow field of view 78 or wider field of view 79. The adjustable feature of the thermopile sensor allows for targeted and isolated temperature measurements of specific portions of the plant canopy.

FIGS. 6a-b illustrate LED grow light fixtures 80 comprising integrated adjustable thermopile sensors 84 according to some embodiments. The field of view of the sensors 84 is adjustable which enables the measurement of the temperature of one or more specific portions of the plant canopy 88. FIG. 6a shows an example of the thermopile sensor being adjusted with a relatively narrow field of view 89a, for example, to measure the temperature of the plant canopy directly or proximately beneath the fixture 80. FIG. 6b shows an example of where the field of view 89b of the sensor is adjusted to wider angle which would provide the average temperature of a more extended portion of the plant canopy 88. The adjustability of the thermopile sensor 84 provides the capability to more accurately measure and monitor the temperature of the plant canopy by excluding, from the field of view of the sensors, areas of non-interest such as open floor space, walls, etc.

The use of an adjustable temperature sensor provides the ability to determine plant and plant canopy temperatures with both accuracy and locational precision. The ability to widen or narrow the field of view of the temperature sensor on the fixture allows for temperature measurements of the entire plant canopy, select portions of the canopy or individual plants. In some embodiments, the adjustment of the sensor is done manually. In other embodiments a the sensor is adjusted via an automated or remote operated controller (e.g., via a wireless or wireline network or personal area network connection). The use of an adjustable sensor is not limited to temperature sensors as will be evident to those skilled in the art. A variety of other adjustable sensors for measuring plant or environmental parameter may be used to determine, with enhanced and/or targeted locational accuracy, plant or environmental parameters.

In some embodiments the temperature data may be used by a programmed controller (not shown) to adjust ventilation or air conditioning within the grow facility or in proximity to the lighting fixture on which the sensor is attached. For example temperature sensor data can be used to in conjunction with ventilation, heating and air conditioning and other systems to monitor and adjust environmental parameters such as air and plant temperature and identify, create or eliminate microclimates within a grow facility. For example, if one or more specific temperature sensors indicate an aberration in temperature, the specific location and plant canopy area associated with that temperature variation will be identified and climate control systems (e.g., via fans or HVAC system) targeting that specific location can be engaged to effect an adjustment in the area's temperature to the desired target temperature or temperature range. In some embodiments, the location and relative position and configuration of each fixture within the grow facility is known. Data communications between the fixture with integrated sensor and a controller via a communications network for control and of activation of actuators including environmental control devices is further described in co-pending U.S. patent application Ser. No. 15/148,194, entitled VEGETATION GROW LIGHT EMBODYING POWER DELIVERY AND DATA COMMUNICATION FEATURES, which is incorporated herein by reference in its entirety.

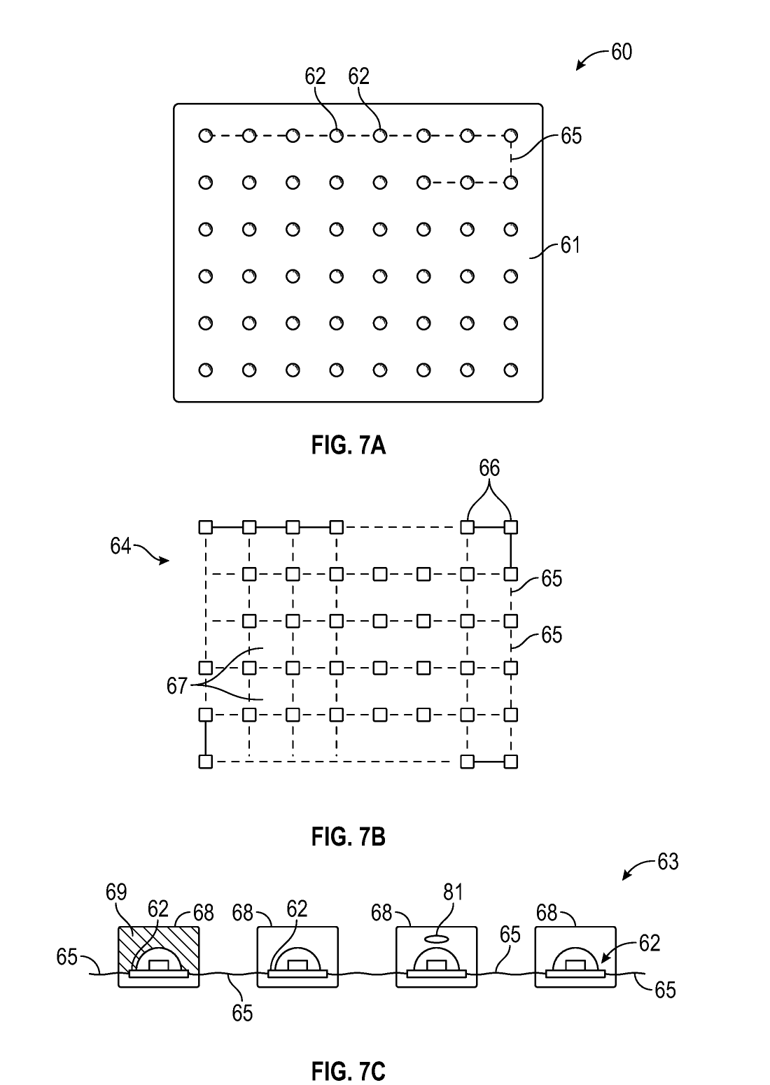

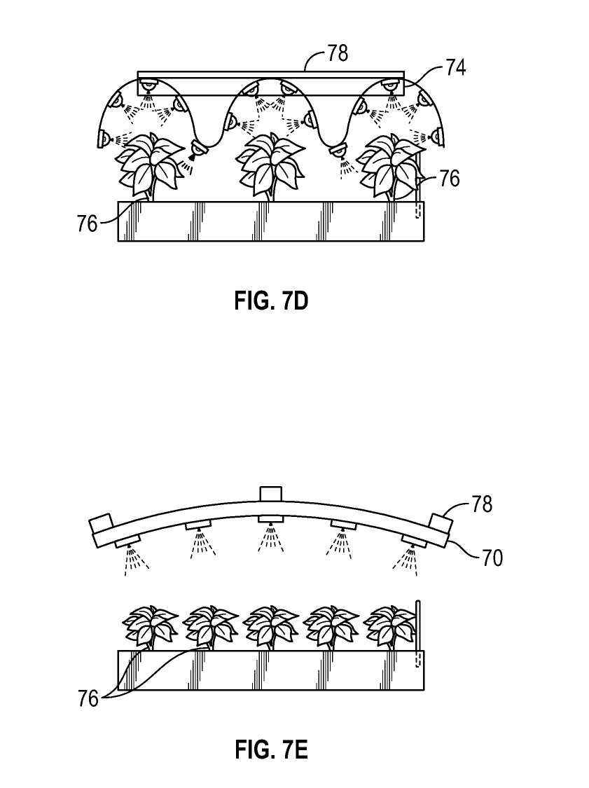

Other embodiments of the invention comprises an LED-based grow light fixture in the form of a flexible sheet with the LEDs distributed in a grid or other pattern on the sheet or as components of the screen. FIG. 7a illustrates an LED grow light fixture 60 in the form or a flexible sheet 61 with a plurality of LEDs 62 distributed in a grid pattern and attached to the flexible sheet 61. The screen may comprise and include the conductors 65 which connect the LEDs 62 to each other and to a power source (e.g., AC power main or DC power supply—not shown). The material of the sheet 61 in this example is aluminum, but can also comprise steel, plastic, or other materials including highly flexible and adjustable materials to allow for the modification of the sheet's 61 shape within a grow application. In one embodiment the LEDs 62 are attached to a printed circuit board (PCB) (not shown) that is in turn integrated into a secondary housing (not shown) that is attached to or integral with the sheet 61. Several LEDs 62 can be attached to a properly sized single PCB. Alternatively, a single LED can be attached to a single smaller PCB with a plurality of these PCBs distributed over the sheet and connected by conductors 63.

In another embodiment as shown in FIG. 7b, an LED grow light fixture 64 comprises a screen or web of LED packages 66. The web material that interconnects the LEDs incorporates conductors 65 to pass current through the LEDs and may be constructed of any material of sufficient strength and flexibility (e.g., plastic). The web or screen of LEDs differs from the above described sheet of LEDs in that the web comprises open gaps 67 between the LEDs where ambient light can traverse and air can flow. Power to the LED web fixture 64 may be supplied by AC or DC power via conductive cabling (not shown).

FIG. 7c illustrates another embodiment of a flexible LED lighting grow fixture 63 in the shape of a flexible string comprising a plurality of LEDs packages 62. In lieu of attaching the LED packages 62 to a sheet or web as described above, conductive flexible cables 65 connect the LED packages 62. This configuration provides the flexibility to form and configure the assembly of LED packages 62 into virtually any desired shape.

As shown in FIG. 7c, each LED package 62 may be enclosed within an enclosure 68. Potting material 69 may optionally be disposed in one or more of the enclosures 68 to achieve the benefits as described elsewhere herein. A secondary lens 81 may be disposed within another one or more of the enclosures 68 to focus or alter the beam angle of the light emitted from the packages 62. The potting material and/or the secondary lens can be used as needed or desired, for example depending on the needs and growing conditions of the vegetation that is illuminated by the grow light fixture. As described further below the flexibility of the LED sheet fixture 60, LED screen fixture 64 and LED string fixture 63 allows for the placing of the LED fixtures in unique configurations and orientations in relation to one or more plants and plant canopies. These capabilities allow for, inter alia, more modularity and customization in a grow facility, more efficient energy use and greater plant yields.

FIG. 7d shows an LED grow lighting fixture 74, for example in the form of a web fixture or string fixture, disposed above plants 76 according to some embodiments. In this example, the LED fixture 74 assumes a flexible shape above the vegetation canopy and individual plants 76. The fixture 74 may be held in a curvilinear shape by attachment to mounting brackets, hangers or other supporting units 78 allowing for the fine tuning and customization of light delivery to the plants. In another one embodiment, as shown in FIG. 7e, an LED sheet fixture 70 is suspended above plants 76 in a curved shape allowing for more focused delivery of light to the plants 76 as compared to a conventional flat or rectilinear grow fixture. The LED lighting fixture 70 may be mounted above or around the vegetation canopy using supports 78. In another embodiment, not illustrated, first LED sheet fixture 70 is installed above the canopy and a second sheet fixture is installed laterally to the canopy, at an acute angle or perpendicular to the first sheet fixture, such that the light is more evenly distributed over the vegetation from both the top and the sides of the canopy.

These embodiments allow for flexibility in the distribution of lighting within a grow facility and provide numerous opportunities for customization and enhancement of the grow operation. Examples of such opportunities include the optimization of the light spectrum for specific plants or photosynthetic processes. In one embodiment, LED light sources can be controlled to emit light at different frequencies/colors and a string or web of LED packages that provides for one LED package to be replaced by another allows for modularity in placing specific LED packages at specific locations on the web or string. Other examples include but are not limited to using potting material (encapsulation) or a secondary lens to provide optical beam angle control and reduce light losses; incorporating LED packages into a flexible frame (or a flexible conductive cable that interconnects the LEDs) permits more optimal placement of the LED lights relative to the growing vegetation. Additional advantages include more convenient and cost effective storage and shipping because the fixtures can be rolled or otherwise collapsed into a manageable shape of reduced volume.

While the invention has been described with reference to exemplary embodiments, it will be understood by those skilled in the art that various changes may be made and equivalents may be substituted for elements thereof without departing from the scope of the invention. It should be understood that the diagrams herein illustrates some of the system components and connections between them and does not reflect specific structural relationships between components, and is not intended to illustrate every element of the overall system, but to provide illustration of some embodiments of the invention to those skilled in the art.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include many variants and embodiments. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for sinking heat from LED grow lights using plant growth media in vertical farming and other plant growth applications comprising:
configuring an LED grow light, comprising an LED light engine on a first side and a heat sink on a second side, to illuminate one or more plant growth areas below the grow light;
configuring a planter, for containing plant grow media, in relation to the LED grow light, such that a portion of the planter is proximal or adjacent to the heat sink of the LED grow light;
depositing a plant grow medium into said planter; and
operating said LED grow light to illuminate said plant grow areas below the grow light wherein heat generated by the LED grow light is at least partially transferred to said grow medium.

2. The method of claim 1 wherein said grow medium is one selected from the group consisting of: water; hydroponic solution; and soil.

3. The method of claim 1 wherein a portion of the base of said planter is configured to be in thermal contact with the heat sink of the LED grow light.

4. The method of claim 1 further comprising circulating a fluid through or adjacent to a first planter to remove heat from the planter.

5. The method of claim 4 further comprising transferring heat from the first planter to a second planter by means of fluid circulation.

6. The method of claim 4 wherein the temperature of a portion of the first planter or grow media therein is monitored and the circulation of fluid is adjusted depending on the temperature of said planter portion or grow media therein.

7. The method of claim 1 wherein a plurality of LED grow light are supported on a rack or other support structure such that a first LED grow light is disposed above a first planter and a second LED grow light is disposed above a second planter and wherein said second planter is disposed above and proximate to said first LED grow light and sinks heat way from said first LED grow light.

8. The method of claim 7 wherein said second planter is in physical contact with the heat sink of the first LED grow light.

9. A system for vertical farming or indoor plant grow operations comprising:
a rack or other support structure comprising at least one lower level and one upper level, the upper level disposed vertically above the lower level;
a first LED grow light comprising an LED light engine, a heat sink and support means for securing it to the lower level such that the LED light engine is oriented in generally a downward direction to illuminate an area below it and the heat sink is oriented generally in an upward direction opposite the light engine;
a second LED grow light with support means for securing it to the upper level such that the LED light engine is oriented generally in a downward direction to illuminate a plant grow area underneath and wherein when both LED grow lights are secured to said rack the second LED grow light will be vertically disposed above the first LED grow light; and
a support means at the lower level for placing and supporting a planter containing plant grow media above and adjacent to the heat sink of said first LED grow light such that when a planter containing grow media is placed adjacent to the heat sink of the first LED grow light, heat generated by the operation of said first LED grow light is at least partially transferred to the planter.

10. The system of claim 9 further comprising a planter for containing grow media wherein the planter is configured on said rack to be in thermal contact with said first LED grow light and receive illumination from said second LED grow light.

11. The system of claim 10 wherein a portion of the base of said planter is configured to be in physical contact with the heat sink of said first LED grow light.

12. The system of claim 9 further comprising means for circulating fluid adjacent or proximate to one or more planters on said rack to remove heat from an LED grow light or from a planter.

13. The system of claim 10 further comprising means for circulating hydroponic fluid through one or more planters on said rack to remove heat from the planter or grow media therein.

14. The system of claim 12 wherein the means for circulating fluid comprises a pump and fluid conduits, a portion of which, are in thermal contact with one or more planters.

15. The system of claim 14 wherein the temperature of a portion of a first planter or grow media therein is monitored and the circulation of fluid is adjusted depending on the temperature of said planter portion or grow media therein.

16. The system of claim 15 wherein the circulation of fluid between planters is regulated in response to one or more planter temperature measurements whereby heat is transferred from a first planter to a second planter in order to adjust or regulate the temperature of one or more of the planters or the grow media therein.

17. The system of claim 10 wherein said planter contains grow media which is warmed by said first LED grow light.

18. An LED grow light with integrated planter component for vertical farming applications comprising:
an LED light engine component;
a heat sink component for sinking heat away from the LED light engine; and
a planter component for containing plant growth media wherein said planter component is in thermal contact with said heat sink component and wherein a portion of said planter component sinks heat away from said LED light engine.

19. The LED grow light of claim 18 further comprising means for carrying circulating fluid within or adjacent said planter component to facilitate heat transfer.

20. The LED grow light of claim 18 wherein the planter component is configured to contain hydroponic grow media and further comprises fluid circulation means for circulating said hydroponic grow media to facilitate heat transfer.
